(19) United States
(12) Patent Application Publication
(10) Pub. No.: US 2025/0100414 A1
(43) Pub. Date: Mar. 27, 2025

(54) ELECTRIC VEHICLE MANAGEMENT APPARATUS, ELECTRIC VEHICLE MANAGEMENT METHOD, AND NON-TRANSITORY COMPUTER-READABLE STORAGE MEDIUM

(71) Applicant: NEC Corporation, Minato-ku, Tokyo (JP)

(72) Inventors: Iori TOKUDA, Tokyo (JP); Tooru IWAMOTO, Tokyo (JP); Takuroh KASHIMA, Tokyo (JP); Norihito OI, Tokyo (JP); Tomoaki MAKINO, Tokyo (JP)

(73) Assignee: NEC Corporation, Minato-ku, Tokyo (JP)

(21) Appl. No.: 18/730,420

(22) PCT Filed: Jan. 31, 2022
(86) PCT No.: PCT/JP2022/003583

§ 371 Date: Jul. 19, 2024

(51) Int. Cl. B60L 53/66; B60L 53/62; B60L 53/65

(52) U.S. Cl. CPC B60L 53/66; B60L 53/62; B60L 53/65

(57) ABSTRACT

An electric vehicle management apparatus (10) includes a charging plan acquisition unit (110), an operation plan acquisition unit (120), and an output unit (150). The charging plan acquisition unit (110) acquires vehicle identification information of at least one electric vehicle incorporated with a battery, and charging plan information indicating a charging schedule period of the electric vehicle associated with the vehicle identification information, in association with each other. The operation plan acquisition unit (120) acquires the vehicle identification information of a target vehicle being the electric vehicle for which operation timing is determined, and the operation timing of the target vehicle, in association with each other. The output unit (150) outputs first vehicle information indicating the target vehicle, when the charging plan information of the target vehicle is absent, or when it is indicated that charging is not completed before the operation timing in the charging plan information.

### TECHNICAL FIELD

The present invention relates to an electric vehicle management apparatus, an electric vehicle management method, and a program.

### BACKGROUND ART

In recent years, an electric vehicle incorporated with a battery has started to become popular. When an electric vehicle as described above is used, it is important to manage a charging state of a battery. For example, Patent Document 1 discloses a system for providing a user of an electric car with a reservation function of an electric power supply point. The system includes a reservation DB. The reservation DB holds information representing a reservation status for each charger at each supply point.

### RELATED DOCUMENT

### Patent Document

Patent Document 1: Japanese Patent Application Publication No. 2020-027429

### SUMMARY OF INVENTION

### Technical Problem

In order to operate an electric vehicle according to a plan, it is necessary to complete charging before an operation start time of the electric vehicle. However, the above-described Patent Document 1 does not consider increasing a possibility that charging is completed before operation start of an electric vehicle.

One example of an object of the present invention is, in view of the above-described problem, to provide an electric vehicle management apparatus, an electric vehicle management method, and a program that enable to increase a possibility that charging is completed before operation start of an electric vehicle.

### Solution to Problem

One aspect of the present invention provides an electric vehicle management apparatus including:
a charging plan acquisition unit that acquires vehicle identification information of at least one electric vehicle incorporated with a battery, and charging plan information indicating a charging schedule period of the electric vehicle associated with the vehicle identification information, in association with each other;
an operation plan acquisition unit that acquires the vehicle identification information of a target vehicle being the electric vehicle for which operation timing is determined, and the operation timing, in association with each other; and
an output unit that outputs first vehicle information indicating the target vehicle, when the charging plan information of the target vehicle is absent, or when it is indicated that charging is not completed before the operation timing in the charging plan information.

One aspect of the present invention provides an electric vehicle management apparatus including:
a charging plan acquisition unit that acquires charging plan information indicating a charging timing of an electric vehicle incorporated with a battery;
a charging state acquisition unit that acquires charging state information indicating a charging state of the electric vehicle at predetermined timing; and
an output unit that determines whether a predetermined output is required by using a charging state indicated by the charging state information and a charging state at the predetermined timing in the charging plan information, and outputs the predetermined information according to a result of the determination.

One aspect of the present invention provides an electric vehicle management method including,
by a computer:
   acquiring vehicle identification information of at least one electric vehicle incorporated with a battery, and charging plan information indicating a charging schedule period of the electric vehicle associated with the vehicle identification information, in association with each other;
   acquiring the vehicle identification information of a target vehicle being the electric vehicle for which operation timing is determined, and the operation timing, in association with each other; and
   outputting first vehicle information indicating the target vehicle, when the charging plan information of the target vehicle is absent, or when it is indicated that charging is not completed before the operation timing in the charging plan information.

One aspect of the present invention provides an electric vehicle management method including,
by a computer:
   acquiring charging plan information indicating a charging timing of an electric vehicle incorporated with a battery;
   acquiring charging state information indicating a charging state of the electric vehicle at predetermined timing; and
   determining whether a predetermined output is required by using a charging state indicated by the charging state information and a charging state at the predetermined timing in the charging plan information, and outputting the predetermined information according to a result of the determination.

One aspect of the present invention provides a program causing a computer to include:
a charging plan acquiring function of acquiring vehicle identification information of at least one electric vehicle incorporated with a battery, and charging plan information indicating a charging schedule period of the electric vehicle associated with the vehicle identification information, in association with each other;
an operation plan acquiring function of acquiring the vehicle identification information of a target vehicle being the electric vehicle for which operation timing is determined, and the operation timing, in association with each other; and
an output function of outputting first vehicle information indicating the target vehicle, when the charging plan information of the target vehicle is absent, or when it is indicated that charging is not completed before the operation timing in the charging plan information.

One aspect of the present invention provides a program causing a computer to include:
a charging plan acquiring function of acquiring charging plan information indicating a charging timing of an electric vehicle incorporated with a battery;
a charging state acquiring function of acquiring charging state information indicating a charging state of the electric vehicle at predetermined timing; and
an output function of determining whether a predetermined output is required by using a charging state indicated by the charging state information and a charging state at the predetermined timing in the charging plan information, and outputting the predetermined information according to a result of the determination.

### Advantageous Effects of Invention

According to one aspect of the present invention, it is possible to increase a possibility that charging is completed before operation start of an electric vehicle.

### BRIEF DESCRIPTION OF THE DRAWINGS

FIG. 1 It is a diagram illustrating a first summary example of an electric vehicle management apparatus according to an example embodiment.

FIG. 2 It is a diagram illustrating a second summary example of the electric vehicle management apparatus according to the example embodiment.

FIG. 3 It is a diagram for describing a usage environment of the electric vehicle management apparatus.

FIG. 4 It is a diagram illustrating one example of a functional configuration of the electric vehicle management apparatus.

FIG. 5 It is a diagram illustrating a hardware configuration example of the electric vehicle management apparatus.

FIG. 6 It is a flowchart illustrating one example of processing to be performed by the electric vehicle management apparatus.

FIG. 7 It is a diagram illustrating a first example of a screen to be displayed after step S30 in FIG. 6.

FIG. 8 It is a diagram illustrating a second example of the screen to be displayed after step S30 in FIG. 6.

FIG. 9 It is a diagram illustrating a third example of the screen to be displayed after step S30 in FIG. 6.

FIG. 10 It is a diagram illustrating a fourth example of the screen to be displayed after step S30 in FIG. 6.

FIG. 11 It is a diagram illustrating one example of a display screen of detail information on an electric vehicle.

FIG. 12 It is a diagram illustrating a modification example in FIG. 11.

FIG. 13 It is a diagram illustrating a case where a user selects a field indicating an electric power consumption amount during a unit period (e.g., this month) on the screen described by using FIG. 11.

FIG. 14 It is a diagram illustrating a case where a user selects a field indicating an accumulated traveling distance on the screen described by using FIG. 11.

FIG. 15 It is a diagram illustrating one example of a screen to be displayed when a user selects a specific portion in a field indicating presence or absence of a simulation for running out of electric power.

FIG. 16 It is a diagram illustrating one example of a screen to be displayed when a user selects a field indicating presence or absence of a charging schedule.

### EXAMPLE EMBODIMENT

Hereinafter, an example embodiment according to the present invention is described by using the drawings. Note that, in all drawings, a similar constituent element is indicated by a similar reference sign, and description thereof is not included as necessary.

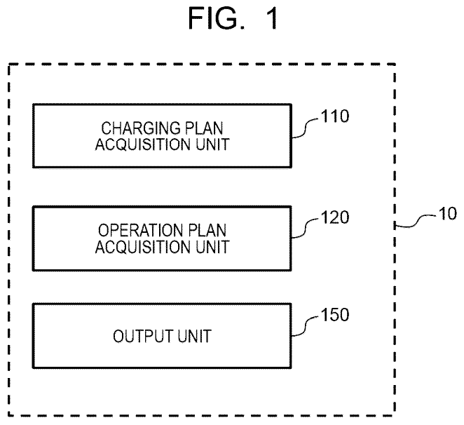

FIG. 1 is a diagram illustrating a first summary example of an electric vehicle management apparatus 10 according to an example embodiment. The electric vehicle management apparatus 10 illustrated in FIG. 1 includes a charging plan acquisition unit 110, an operation plan acquisition unit 120, and an output unit 150. The charging plan acquisition unit 110 acquires vehicle identification information of at least one electric vehicle incorporated with a battery, and charging plan information indicating a charging schedule period of the electric vehicle associated with the vehicle identification information, in association with each other. The operation plan acquisition unit 120 acquires the vehicle identification information of a target vehicle being the electric vehicle for which operation timing is determined, and operation timing of the target vehicle, in association with each other. The output unit 150 outputs first vehicle information indicating the target vehicle, when the charging plan information of the target vehicle is absent, or when it is indicated that charging is not completed before the operation timing in the charging plan information.

According to the electric vehicle management apparatus 10, the output unit 150 outputs the first vehicle information indicating the target vehicle, when it is indicated that charging is not completed before operation timing in charging plan information. Therefore, a user of the electric vehicle management apparatus 10 can recognize the electric vehicle having a possibility that charging is not completed before operation start of the electric vehicle, and take a measure for the electric vehicle. Thus, it is possible to increase a possibility that charging is completed before operation start of the electric vehicle.

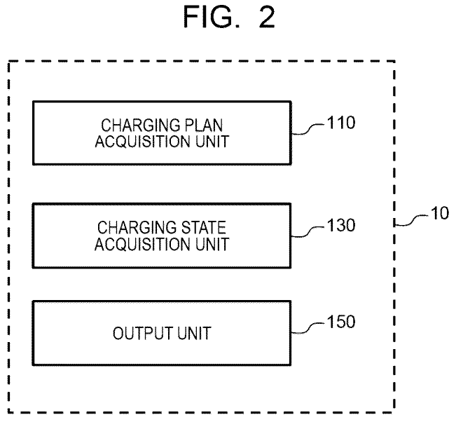

FIG. 2 is a diagram illustrating a second summary example of the electric vehicle management apparatus 10 according to the example embodiment. The electric vehicle management apparatus 10 illustrated in FIG. 2 includes the charging plan acquisition unit 110, a vehicle data acquisition unit 140, and the output unit 150. As described above, the charging plan acquisition unit 110 acquires charging plan information indicating a charging timing of an electric vehicle incorporated with a battery. The vehicle data acquisition unit 140 acquires charging state information indicating a charging state of the electric vehicle at predetermined timing. In FIG. 2, the output unit 150 determines whether a predetermined output is required by using a charging state indicated by charging state information and a charging state at the above-described predetermined timing in charging plan information, and outputs predetermined information according to a result of the determination.

According to the electric vehicle management apparatus 10, the output unit 150 determines whether a predetermined output is required by using a charging state indicated by charging state information and a charging state in charging plan information, and outputs predetermined information according to a result of the determination. Therefore, a user of the electric vehicle management apparatus 10 can recognize, by confirming a predetermined output, that an electric vehicle serving as a processing target has a possibility that charging is not completed before operation start. In this case, a user of the electric vehicle management apparatus 10 can take a measure for the electric vehicle. Thus, it is possible to increase a possibility that charging is completed before operation start of the electric vehicle. Note that, a “possibility that charging is not completed” may be determined, for example, by comparing a target SOC with a predicted SOC included in a charging plan.

Note that, a “state in which charging is completed” is, for example, “SOC is reaching a preset target value”. In this case, a target value of SOC may be included in charging plan information, or may be set manually on the spot. Further, when the target value of SOC is included in charging plan information, the target value may be acquired, for example, from operation plan information of an electric vehicle, or may be manually set at a time of generation of charging plan information. Note that, when operation plan information includes a traveling time or a traveling distance per operation day, the target value of SOC may be computed from these values.

Note that, the target value of SOC may be set in advance as a default value. The value is optional, but may be “100%” in some cases.

Further, an electric vehicle is, for example, any of an electric car, an electric two-wheeler, and a battery-driven train, but is not limited thereto. Hereinafter, a detail example of the electric vehicle management apparatus 10 is described. Further, when an electric vehicle is a delivery vehicle to be operated by a shipping company, the electric vehicle management apparatus 10 is used by the shipping company.

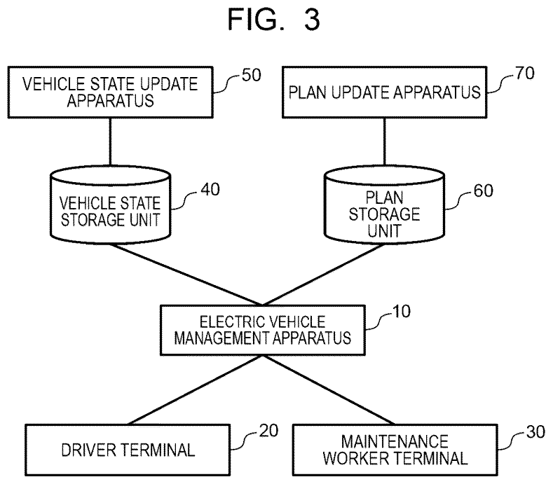

FIG. 3 is a diagram for describing a usage environment of the electric vehicle management apparatus 10. The electric vehicle management apparatus 10 is an apparatus for managing an electric vehicle incorporated with a battery, and is used together with at least one of a driver terminal 20 and a maintenance worker terminal 30, a vehicle state storage unit 40, a vehicle state update apparatus 50, a plan storage unit 60, and a plan update apparatus 70. Note that, the electric vehicle management apparatus 10 is further used together with a simulation apparatus for simulating whether running out of electric power occurs when an electric vehicle travels according to a scheduled rudo, as necessary.

The driver terminal 20 is a terminal carried by a driver of an electric vehicle, and the maintenance worker terminal 30 is a terminal carried by a maintenance worker of an electric vehicle. When an electric vehicle to be managed by the electric vehicle management apparatus 10 is plural, and a driver is determined for each of the plurality of electric vehicles, the driver terminal 20 is provided for each of a plurality of drivers. Further, when a maintenance worker of an electric vehicle is plural, the maintenance worker terminal 30 is provided for each of a plurality of maintenance workers. Further, the electric vehicle management apparatus 10 outputs necessary information to at least one of the driver terminal 20 and the maintenance worker terminal 30. One example of the necessary information is the first vehicle information described by using FIG. 1, and the predetermined information described by using FIG. 2.

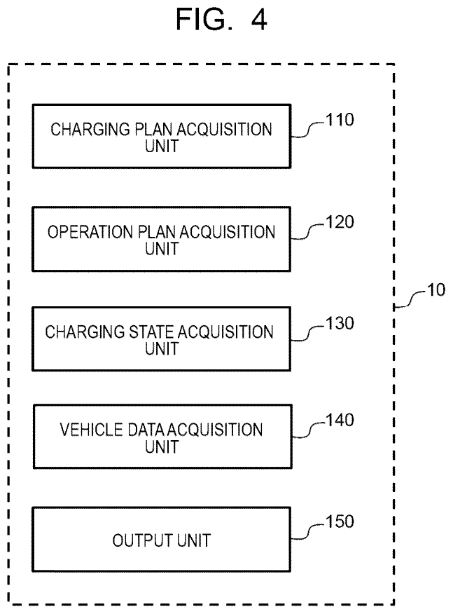

The vehicle state storage unit 40 stores vehicle state information indicating a state of an electric vehicle. A detail example of the vehicle state information is described by using FIG. 4. Further, the vehicle state storage unit 40 also stores a history on each item included in the vehicle state information. Therefore, when information stored in the vehicle state storage unit 40 is used, the electric vehicle management apparatus 10 can generate information, for example, a graph, indicating a transition in each item included in the vehicle state information.

Note that, when a plurality of electric vehicles are present, the vehicle state storage unit 40 stores vehicle identification information and vehicle state information of the electric vehicle in association with each other for each of the plurality of electric vehicles.

The vehicle state update apparatus 50 periodically updates information stored in the vehicle state storage unit 40. For example, the vehicle state update apparatus 50 acquires latest vehicle state information by communicating with an electric vehicle, and causes the vehicle state storage unit 40 to store the vehicle information. A communication method of the vehicle state update apparatus 50 with an electric vehicle may be, for example, wireless communication, or may be wired communication via a charging connector. In the former case, communication timing of the vehicle state update apparatus 50 with an electric vehicle is, for example, a period during which the electric vehicle is being charged, but is not limited thereto. Further, a time interval at which the vehicle state update apparatus 50 updates the vehicle state storage unit 40 is, for example, equal to or more than one minute and equal to or less than one hour, but may be longer than one hour.

The plan storage unit 60 stores charging plan information and operation plan information. The charging plan information indicates vehicle identification information of an electric vehicle, and a charging schedule period of the electric vehicle associated with the vehicle identification information. The operation plan information includes information in which vehicle identification information of a target vehicle being an electric vehicle for which operation timing is determined, and the operation timing are associated with each other. Details on the charging plan information and the operation plan information are described by using FIG. 4.

The plan update apparatus 70 updates charging plan information and operation plan information stored in the plan storage unit 60. The plan update apparatus 70 may update the charging plan information and the operation plan information in response to an instruction of a user of the plan update apparatus 70, or may update the charging plan information and the operation plan information according to predetermined algorithm. Further, a user of the plan update apparatus 70 may correct, by manual input, the charging plan information and the operation plan information generated according to the predetermined algorithm.

In the example illustrated in FIG. 3, the vehicle state storage unit 40 and the plan storage unit 60 are located outside the electric vehicle management apparatus 10. However, at least one of the vehicle state storage unit 40 and the plan storage unit 60 may be a part of the electric vehicle management apparatus 10.

FIG. 4 is a diagram illustrating one example of a functional configuration of the electric vehicle management apparatus 10. The electric vehicle management apparatus 10 includes the charging plan acquisition unit 110, the operation plan acquisition unit 120, a charging state acquisition unit 130, the vehicle data acquisition unit 140, and the output unit 150.

The charging state acquisition unit 110 acquires charging plan information from the plan storage unit 60. The charging plan information indicates vehicle identification information of an electric vehicle, and a charging schedule period of the electric vehicle associated with the vehicle identification information. Information indicating the charging schedule period includes, for example, identification information of a charging connector, a charging start date and time, and a charging finish date and time. When the electric vehicle management apparatus 10 manages a plurality of electric vehicles, the charging plan information indicates vehicle identification information and a charging schedule period for each of the plurality of electric vehicles. Note that, the charging plan information may further include a predicted SOC at a time when charging is completed.

The operation plan acquisition unit 120 acquires operation plan information from the plan storage unit 60. The operation plan information includes information in which vehicle identification information of a target vehicle being an electric vehicle for which operation timing is determined, and the operation timing are associated with each other. The operation timing includes at least an operation start date and time, but may further include an operation finish date and time. When a plurality of target vehicles are present, the operation plan information indicates vehicle identification information and operation timing for each of the plurality of target vehicles.

The charging state acquisition unit 130 acquires charging state information from the vehicle state storage unit 40. The charging state information indicates a charging state of an electric vehicle at predetermined timing. Herein, the predetermined timing may be a current time, or may be timing earlier than a current time by a predetermined time. One example of the predetermined time is equal to or more than one minute and equal to or less than one hour, but the predetermined time may be longer than the above. The charging state includes, for example, at least two of a state in which a charging connector is unconnected, a state in which a charging connector is connected, a state in which charging is being performed, and a state in which charging is completed. For example, when a charging state is a “state in which a charging connector is unconnected”, it is clear that charging of the electric vehicle is not yet performed. Further, when a charging state is a “state in which a charging connector is connected”, it is clear that charging of the electric vehicle is started immediately. When a plurality of electric vehicles are present, the charging state information indicates vehicle identification information and a charging state for each of the plurality of electric vehicles.

The vehicle data acquisition unit 140 acquires vehicle state information of an electric vehicle from the vehicle state storage unit 40. The vehicle state information includes, for example, various parameters of a battery, an average electricity efficiency (one example of a unit is km/kwh), a total traveling distance, the number of times of fast charging, information indicating whether charging is being performed, information indicating whether charging is completed, information indicating whether there is a charging plan, a time until full charge, and a current location. The various parameters of a battery include, for example, SOC and SOH.

Further, as described by using FIG. 3, the vehicle state storage unit 40 also stores a history on each item included in vehicle state information. The vehicle data acquisition unit 140 also acquires these histories as necessary.

The output unit 150 determines information to be output, and output timing of the information by using the pieces of information acquired by the charging plan acquisition unit 110, the operation plan acquisition unit 120, the charging state acquisition unit 130, and the vehicle data acquisition unit 140, and outputs the information according to a determination result. One example of an output destination of the information is at least one of the driver terminal 20 and the maintenance worker terminal 30.

For example, as described by using FIG. 1, the output unit 150 outputs the first vehicle information indicating a target vehicle, when charging plan information of the target vehicle being an electric vehicle for which an operation timing is determined is absent, or when it is indicated that charging is not completed before operation timing in the charging plan information. Herein, “when it is indicated that charging is not completed before operation timing in charging plan information” is, for example, a case where a charging completion date and time indicated by the charging plan information is later than a date and time indicated by the operation timing.

Further, as described by using FIG. 2, the output unit 150 determines whether a predetermined output is required by using a charging state indicated by charging state information at predetermined timing of a certain electric vehicle, and a charging state at the predetermined timing in charging plan information, and outputs predetermined information according to a result of the determination. For example, when a difference between a charging state indicated by charging state information at predetermined timing, and a charging state at the predetermined timing in charging plan information does not satisfy a criterion, for example, when the charging states do not match each other, the output unit 150 outputs information being capable of determining the electric vehicle. As one example, when a charging state indicated by charging state information at predetermined timing is a “state in which a charging connector is unconnected”, but charging is being performed at the timing in charging plan information, the output unit 150 outputs information being capable of determining the electric vehicle. However, when a charging state indicated by charging state information advances as compared with charging plan information, for example, when charging is being performed in charging plan information, but charging is completed in charging state information, it is not necessary to output predetermined information. In this case, the output unit 150 outputs predetermined information, when a charging state indicated by charging state information is retarded as compared with charging plan information.

Note that, the output unit 150 also outputs another piece of information as necessary. One example of the another piece of information is a transition in at least one item included in vehicle state information. A detail example of information to be output from the output unit 150 is described later by using another drawing.

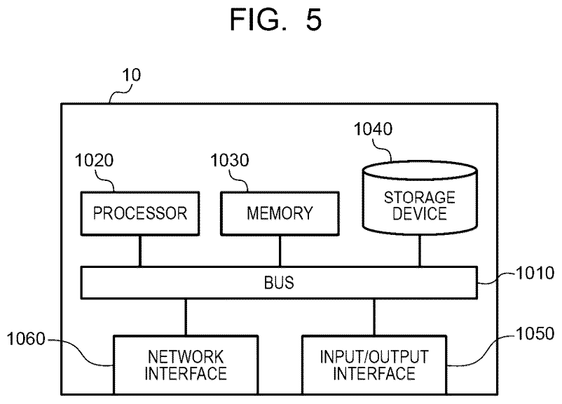

FIG. 5 is a diagram illustrating a hardware configuration example of the electric vehicle management apparatus 10. The electric vehicle management apparatus 10 includes a bus 1010, a processor 1020, a memory 1030, a storage device 1040, an input/output interface 1050, and a network interface 1060.

The bus 1010 is a data transmission path along which the processor 1020, the memory 1030, the storage device 1040, the input/output interface 1050, and the network interface 1060 mutually transmit and receive data. However, a method of mutually connecting the processor 1020 and the like is not limited to bus connection.

The processor 1020 is a processor to be achieved by a central processing unit (CPU), a graphics processing unit (GPU), or the like.

The memory 1030 is a main storage apparatus to be achieved by a random access memory (RAM) or the like.

The storage device 1040 is an auxiliary storage apparatus to be achieved by a hard disk drive (HDD), a solid state drive (SSD), a removable medium such as a memory card, a read only memory (ROM), or the like. The storage device 1040 stores a program module for achieving each function (e.g., the charging plan acquisition unit 110, the operation plan acquisition unit 120, the charging state acquisition unit 130, the vehicle data acquisition unit 140, and the output unit 150) of the electric vehicle management apparatus 10. Each function associated with a program module is achieved by causing the processor 1020 to read each program module in the memory 1030 and execute the program module. Further, in some cases, the storage device 1040 also functions as at least one of the vehicle state storage unit 40 and the plan storage unit 60.

The input/output interface 1050 is an interface for connecting the electric vehicle management apparatus 10 to various pieces of input/output equipment.

The network interface 1060 is an interface for connecting the electric vehicle management apparatus 10 to a network. The network is, for example, a local area network (LAN) or a wide area network (WAN). A method of connecting the network interface 1060 to the network may be wireless connection, or may be wired connection. The electric vehicle management apparatus 10 may communicate with the driver terminal 20 and the maintenance worker terminal 30 via the network interface 1060. Further, the electric vehicle management apparatus 10 may communicate with the vehicle state storage unit 40 and the plan storage unit 60 via the network interface 1060.

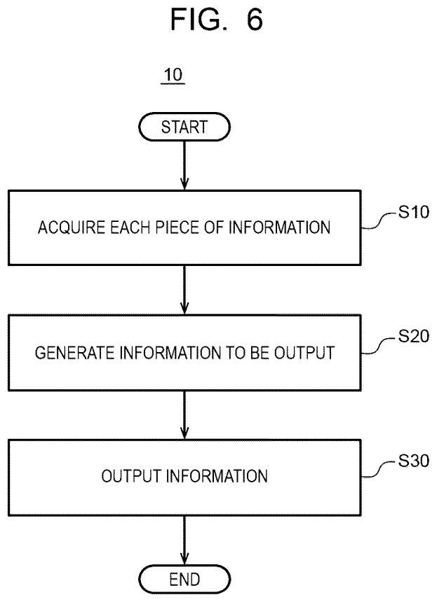

FIG. 6 is a flowchart illustrating one example of processing to be performed by the electric vehicle management apparatus 10. In addition to processing illustrated in FIG. 6, the vehicle state update apparatus 50 periodically updates information stored in the vehicle state storage unit 40. Further, the plan storage unit 60 repeatedly updates information stored in the plan storage unit 60 as necessary. Then, when a predetermined input is received from a user of the electric vehicle management apparatus 10, the electric vehicle management apparatus 10 performs processing illustrated in FIG. 6.

First, the charging plan acquisition unit 110 acquires charging plan information, the operation plan acquisition unit 120 acquires operation plan information, the charging state acquisition unit 130 acquires charging state information, and the vehicle data acquisition unit 140 acquires vehicle state information (step S10).

Subsequently, the output unit 150 generates information to be output to at least one of the driver terminal 20 and the maintenance worker terminal 30. One example of the information is as described by using FIG. 4. However, the output unit 150 may output a table including all pieces of information described by using FIG. 4. One example of the table is a table in which each piece of information related to an electric vehicle is indicated in a list format. When a plurality of electric vehicles to be managed by the electric vehicle management apparatus 10 are present, the table indicates each piece of information for each of the plurality of electric vehicles (step S20).

Subsequently, the output unit 150 outputs the generated information to at least one of the driver terminal 20 and the maintenance worker terminal 30. Note that, the output unit 150 may output the information to a terminal of an administrator who administrates a driver and a maintenance worker (step S30). At this occasion, the output unit 150 may determine a driver or a maintenance worker of an electric vehicle serving as an output target, and output the information only to the driver terminal 20 and the maintenance worker terminal 30 of the determined person. To do so, the electric vehicle management apparatus 10 is needed to store information indicating the driver terminal 20 and the maintenance worker terminal 30 associated with an electric vehicle for each piece of vehicle identification information of the electric vehicle.

Thereafter, at least one of the driver terminal 20 and the maintenance worker terminal 30 displays the output information on a display.

Note that, processing illustrated in FIG. 6 may be performed when a predetermined input is received from the driver terminal 20 or the maintenance worker terminal 30, for example, when a driver or a maintenance worker wishes to confirm a state of an electric vehicle. In this case, the electric vehicle management apparatus 10 does not set all electric vehicles as a processing target, but may perform pieces of processing illustrated in step S20 and step S30 for an electric vehicle associated with the driver terminal 20 or the maintenance worker terminal 30. To do so, the electric vehicle management apparatus 10 is needed to store information indicating the driver terminal 20 and the maintenance worker terminal 30 associated with an electric vehicle for each piece of vehicle identification information of the electric vehicle.

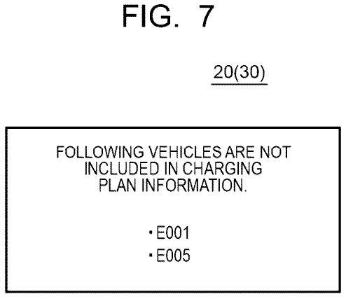

FIG. 7 is a diagram illustrating a first example of a screen to be displayed on at least one of the driver terminal 20 and the maintenance worker terminal 30 after step S30 in FIG. 6. The screen illustrated in FIG. 7 includes vehicle identification information of an electric vehicle in which charging is not completed before operation timing among electric vehicles included in operation plan information. The vehicle identification information indicates an electric vehicle not being included in charging plan information, and an electric vehicle for which charging is not completed before operation timing in charging plan information.

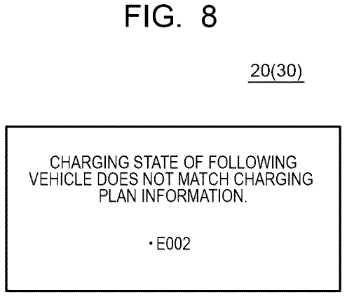

Note that, the output unit 150 of the electric vehicle management apparatus 10 may cause a printing apparatus to print information indicated on the screen. This is the same also for an example in FIG. 8 and thereafter.

FIG. 8 is a diagram illustrating a second example of a screen to be displayed on at least one of the driver terminal 20 and the maintenance worker terminal 30 after step S30 in FIG. 6. The screen illustrated in FIG. 8 includes vehicle identification information of an electric vehicle in which a charging state indicated by charging state information, and a charging state in charging plan information do not match each other. The vehicle identification information indicates, for example, an electric vehicle in which a charging state indicated by charging state information is retarded as compared with charging plan information.

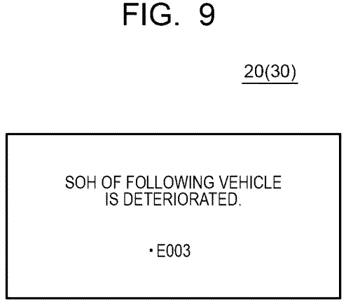

FIG. 9 is a diagram illustrating a third example of a screen to be displayed on at least one of the driver terminal 20 and the maintenance worker terminal 30 after step S30 in FIG. 6. In the example illustrated in FIG. 9, the vehicle data acquisition unit 140 acquires, in step S10, SOH of each electric vehicle, and a history on SOH. Then, the output unit 150 outputs information indicating an electric vehicle in which a deterioration state of SOH satisfies a criterion, for example, vehicle identification information of the electric vehicle. A case where a deterioration state of SOH satisfies a criterion is at least one of a case where an absolute value of SOH becomes equal to or less than a reference value, and a case where a lowering amount of SOH during a unit period becomes equal to or more than a reference value. Note that, one example of the unit period is one month or two months, but the unit period is not limited thereto.

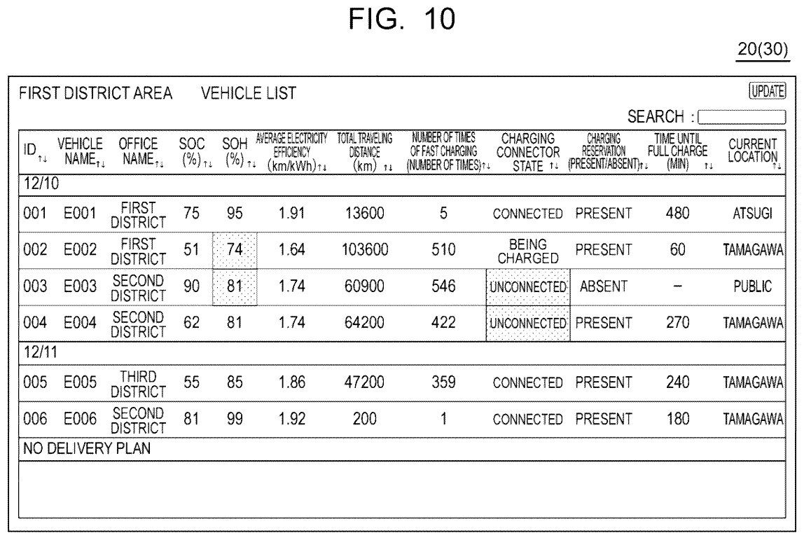

FIG. 10 is a diagram illustrating a fourth example of a screen to be displayed on at least one of the driver terminal 20 and the maintenance worker terminal 30 after step S30 in FIG. 6. In the example illustrated in FIG. 10, the electric vehicle management apparatus 10 is used by a delivery company. The electric vehicle is a vehicle to be used by the delivery company for delivery, and is, for example, a truck.

The screen illustrated in FIG. 10 indicates, in a table format, vehicle information at a time of generation of a screen for each of a plurality of electric vehicles to be managed by the electric vehicle management apparatus 10. The vehicle information includes vehicle identification information, an affiliated office name, a parameter (e.g., SOC and SOH) of a battery, an average electricity efficiency based on a driving result so far, a total traveling distance, the number of times of fast charging, a charging state (described as a charging connector state in FIG. 9) indicated by charging state information, presence or absence of charging reservation, namely, a charging plan, a predicted time until full charge when charging reservation is present, and a current location of the electric vehicle.

In the table, regarding an electric vehicle in which operation timing is determined but the electric vehicle is not included in charging plan information, a cell “charging reservation” is indicated as “absent”. The information is one example of “first vehicle information” described by using FIG. 1.

Further, in the table, regarding an electric vehicle in which a charging schedule period is set in charging plan information, a cell “charging reservation” is indicated as “present”. The information is one example of information indicating an electric vehicle in which a charging schedule period is set, namely, second vehicle information. Then, the first vehicle information and the second vehicle information are displayed in the same column. This allows a user of the electric vehicle management apparatus 10 to easily confirm presence or absence of charging reservation for a plurality of electric vehicles. Note that, when a row and a column are opposite with respect to the example illustrated in FIG. 10, the first vehicle information and the second vehicle information are displayed in the same row.

Further, a cell “first vehicle information”, namely, a cell in which “charging reservation” is “absent” is displayed in a different mode with respect to a cell “second vehicle information”, namely, a cell in which “charging reservation” is “present”. One example of a change in the display mode is at least one of changing a color of a character, changing a size of a character, changing a format of a character, changing a color or hatching of a cell, and giving a predetermined mark. This allows a user of the electric vehicle management apparatus 10 to further easily confirm presence or absence of charging reservation for a plurality of electric vehicles.

Further, in the table, when a difference between charging state information at a timing of generation of a screen, and a charging state at that timing in charging plan information does not satisfy a criterion, for example, when the pieces of information do not match each other, a cell “charging state” is displayed in a different mode with respect to a case where the difference satisfies the criterion. One example of a condition in which a display mode is made different is, as described by using FIG. 4, a case where a charging state indicated by charging state information is a “state in which a charging connector is unconnected”, but charging is being performed at that timing in charging plan information. Also in this example, one example of a change in the display mode is at least one of changing a color of a character, changing a size of a character, changing a format of a character, changing a color or hatching of a cell, and giving a predetermined mark. Note that, the display mode is one example of “predetermined information” described by using FIG. 2.

Further, in the table, a cell “SOH” of an electric vehicle in which a deterioration state of SOH satisfies a criterion is displayed in a different mode with respect to a case where the deterioration state does not satisfy the criterion. The mode of the cell is one example of information indicating an electric vehicle in which a deterioration state of SOH satisfies a criterion. Also in this example, one example of a change in the display mode is at least one of changing a color of a character, changing a size of a character, changing a format of a character, changing a color or hatching of a cell, and giving a predetermined mark. Note that, the change in the display mode is one example of “predetermined information” described by using FIG. 2.

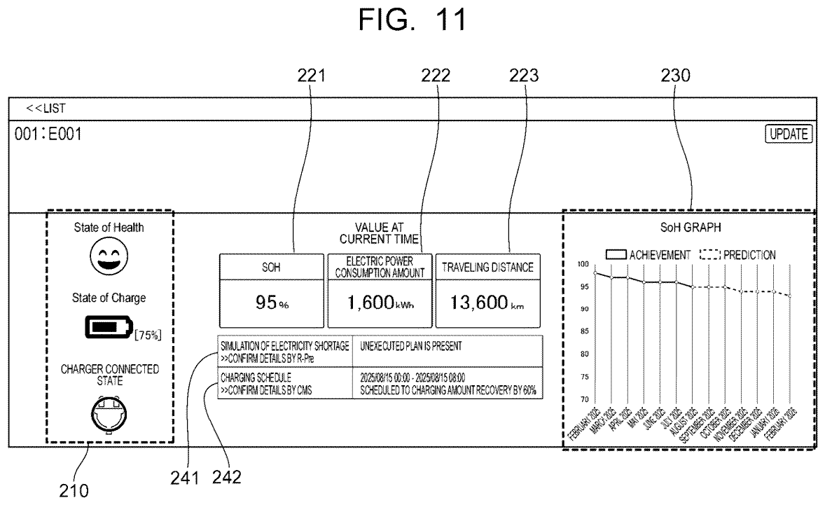

Further, when a specific cell is selected in the table, the output unit 150 causes the driver terminal 20 or the maintenance worker terminal 30 to display a screen indicating detail information on an electric vehicle associated with the cell. Hereinafter, one example of the screen is described by using FIGS. 11 to 14.

FIG. 11 is a diagram illustrating one example of a display screen of detail information on an electric vehicle. The example illustrated in FIG. 11 includes a state indicating field 210 indicating whether a current SOH, SOC, and a charging state (charging equipment connected state) are normal, a field 221 indicating a value of SOH, a field 222 indicating an electric power consumption amount during a latest unit period (e.g., this month), a field 223 indicating an accumulated traveling distance, a graph field 230 indicating a graph, a field 241 indicating presence or absence of a simulation for running out of electric power, and a field 242 indicating presence or absence of a charging schedule.

Herein, information indicated by a graph displayed in the graph field 230 is switched when a user selects from among the fields 221, 222, and 223. In FIG. 11, the graph field 230 indicates a graph when the field 221 indicating SOH is selected. The graph indicates a transition in the SOH for each unit period, for example, a transition for each month. The transition includes an achievement value so far, and a predicted value from now on. Note that, the predicted value is stored, for example, in the vehicle state storage unit 40, as a part of vehicle state information.

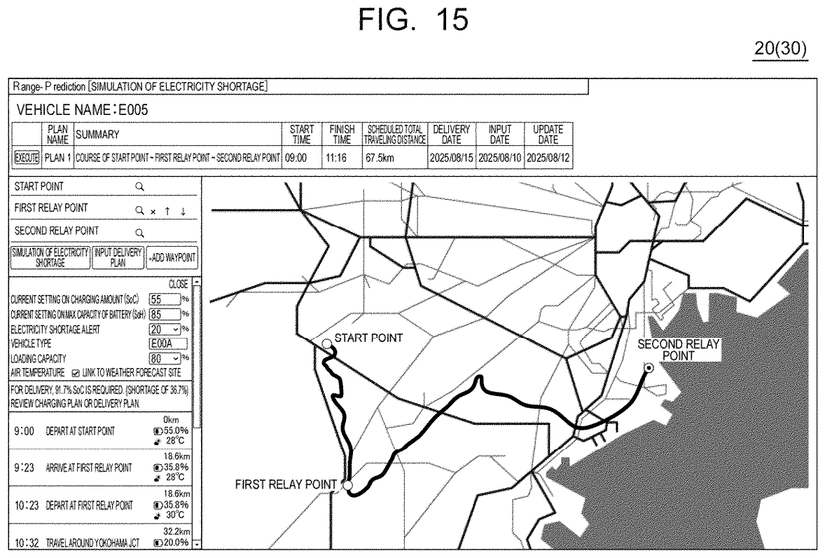

Further, when a user selects a specific portion within the field 241 in a case where a simulation of running out of electric power is present, the output unit 150 causes the driver terminal 20 or the maintenance worker terminal 30 to display a screen indicating a simulation result of running out of electric power. The screen is described later by using FIG. 15.

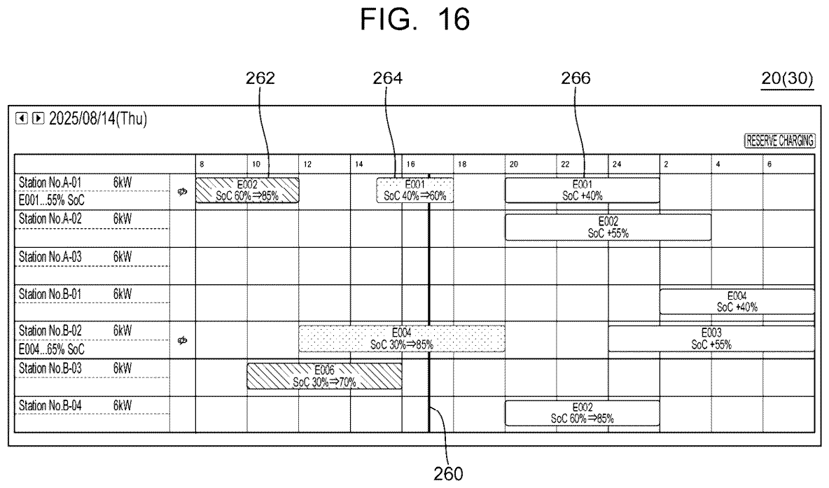

Further, when a user selects a specific portion within the field 242 in a case where a charging schedule is present, the output unit 150 causes the driver terminal 20 or the maintenance worker terminal 30 to display a screen indicating charging plan information. The screen is described later by using FIG. 16.

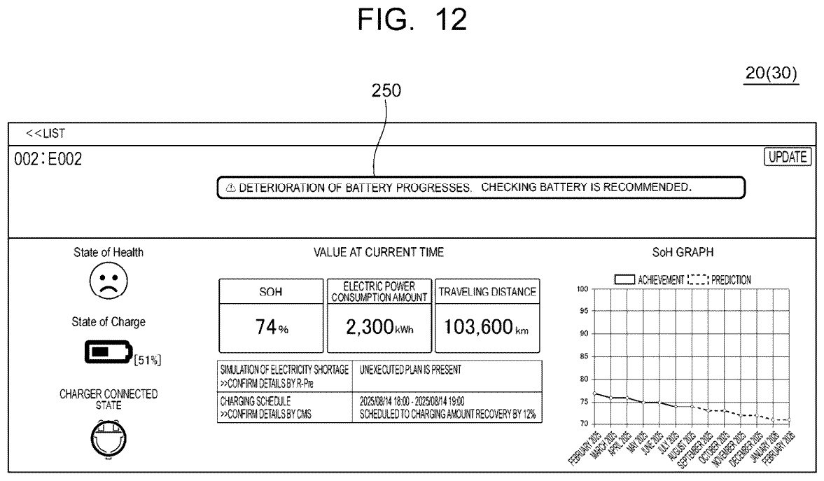

FIG. 12 is a diagram illustrating a modification example of FIG. 11. FIG. 12 indicates a case where a deterioration state of SOH satisfies a criterion, and also includes, in addition to the information illustrated in FIG. 11, information 250 indicating that SOH is deteriorated.

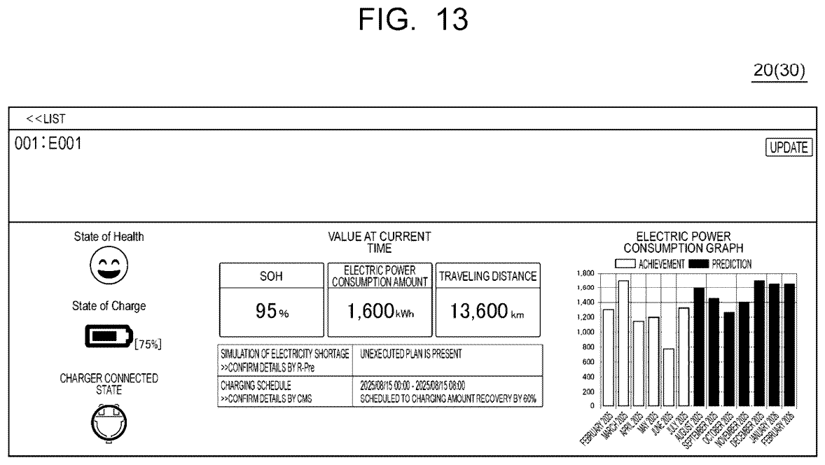

FIG. 13 is a diagram illustrating a case where a user selects the field 222 indicating an electric power consumption amount during a unit period (e.g., this month) on the screen described by using FIG. 11. In this case, a graph indicated in the graph field 230 indicates a transition in the electric power consumption amount of the electric vehicle for each unit period, for example, for each month. The transition includes an achievement value so far, and a predicted value from now on. Note that, the predicted value is stored, for example, in the vehicle state storage unit 40, as a part of vehicle state information.

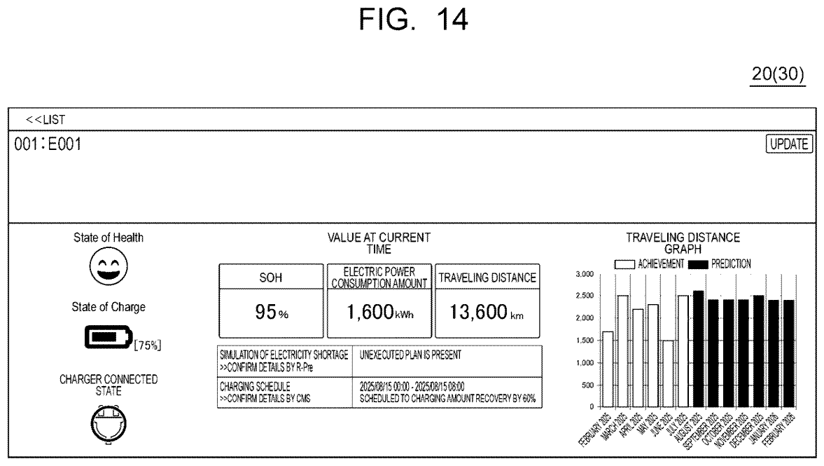

FIG. 14 is a diagram illustrating a case where a user selects the field 223 indicating an accumulated traveling distance on the screen described by using FIG. 11. In this case, a graph indicated in the graph field 230 indicates a transition in the traveling distance of the electric vehicle for each unit period, for example, for each month. The transition includes an achievement value so far, and a predicted value from now on. Note that, the predicted value is stored, for example, in the vehicle state storage unit 40, as a part of vehicle state information.

FIG. 15 is a diagram illustrating one example of a screen to be displayed on the driver terminal 20 or the maintenance worker terminal 30 by the output unit 150, when a user selects a specific portion in the field 241 indicating presence or absence of a simulation of running out of electric power on the screen in FIGS. 11 to 14. The screen is generated by using information acquired from, for example, a simulation apparatus for performing a simulation of running out of electric power. The information may be stored in advance in the vehicle state storage unit 40, or may be acquired from the simulation apparatus when the screen in FIG. 15 is displayed.

The screen includes a simulation result of running out of electric power, and information used in the simulation of running out of electric power. The information used in a simulation of running out of electric power includes, for example, a traveling route, a current SOC and SOH, a threshold value of SOH for outputting an alert of running out of electric power, a vehicle type, and a loading capacity (% with respect to a maximum value). The simulation result of running out of electric power includes an estimated value of SOC at a plurality of points on a traveling route, whether a current SOC is sufficient for traveling along the traveling route, and a shortage amount (%) of SOC.

FIG. 16 is a diagram illustrating one example of a screen to be displayed on the driver terminal 20 or the maintenance worker terminal 30 by the output unit 150, when a user selects the field 242 indicating presence or absence of a charging schedule on the screen in FIGS. 11 to 14. The screen indicates charging plan information. Specifically, the screen indicates vehicle identification information and a charging schedule period of an electric vehicle being scheduled to be charged by a charging connector, for each charging connector.

Further, in FIG. 16, a horizontal axis denotes time. Further, FIG. 16 includes a vertical line 260 indicating a current date and time. Then, an indication 262 corresponding to a charging schedule period earlier than the line, an indication 264 corresponding to a charging schedule period overlapping the line, and an indication 266 corresponding to a charging period later than the line are indicated in different modes from one another. One example of the change in the mode is at least one of changing a color of a character, changing a size of a character, changing a format of a character, changing a color or hatching of a cell, and giving a predetermined mark. This allows a user of the driver terminal 20 and the maintenance worker terminal 30 to easily recognize each of an electric vehicle in which charging is completed, an electric vehicle being charged, and an electric vehicle scheduled to be charged from now on.

In the foregoing, according to the present example embodiment, the output unit 150 outputs first vehicle information indicating an electric vehicle indicating that charging is not completed before operation timing in charging plan information. Therefore, a user of the electric vehicle management apparatus 10 can recognize an electric vehicle having a possibility that charging is not completed before operation start of the electric vehicle, and take a measure for the electric vehicle. Thus, it is possible to increase a possibility that charging is completed before operation start of an electric vehicle.

Further, according to the present example embodiment, the output unit 150 determines whether a predetermined output is required by using a charging state indicated by charging state information and a charging state in charging plan information, and outputs predetermined information according to a result of the determination. Therefore, a user of the electric vehicle management apparatus 10 can recognize, by confirming a predetermined output, that an electric vehicle serving as a processing target has a possibility that charging is not completed before operation start. Thus, it is possible to increase a possibility that charging is completed before operation start of an electric vehicle.

In the foregoing, an example embodiment according to the present invention has been described with reference to the drawings, however, these are examples of the present invention, and various configurations other than the above can also be adopted.

Further, in a plurality of flowcharts used in the above description, a plurality of processes (pieces of processing) are described in order, however, an order of execution of processes to be performed in each example embodiment is not limited to the order of description. In each example embodiment, the illustrated order of processes can be changed within a range that does not adversely affect a content. Further, the above-described example embodiments can be combined, as far as contents do not conflict with each other.

A part or all of the above-described example embodiment may also be described as the following supplementary notes, but is not limited to the following.

1. An electric vehicle management apparatus including:
a charging plan acquisition unit that acquires vehicle identification information of at least one electric vehicle incorporated with a battery, and charging plan information indicating a charging schedule period of the electric vehicle associated with the vehicle identification information, in association with each other;
an operation plan acquisition unit that acquires the vehicle identification information of a target vehicle being the electric vehicle for which operation timing is determined, and the operation timing, in association with each other; and
an output unit that outputs first vehicle information indicating the target vehicle, when the charging plan information of the target vehicle is absent, or when it is indicated that charging is not completed before the operation timing in the charging plan information.
   2. The electric vehicle management apparatus according to supplementary note 1, wherein
the electric vehicle is plural, and
the output unit outputs second vehicle information indicating the electric vehicle in which the charging schedule period is set.
   3. The electric vehicle management apparatus according to supplementary note 2, wherein
the output unit causes to display or print the first vehicle information and the second vehicle information in a different mode from each other.
   4. The electric vehicle management apparatus according to supplementary note 3, wherein
the output unit outputs a table indicating a state of each of the plurality of electric vehicles, and,
in the table, the first vehicle information and the second vehicle information are indicated in a same row or a same column.
   5. The electric vehicle management apparatus according to any one of supplementary notes 1 to 4, further including
a charging state acquisition unit that acquires charging state information indicating a charging state of the electric vehicle at predetermined timing, wherein
the output unit determines whether a predetermined output is required by using a charging state indicated by the charging state information and a charging state at the predetermined timing in the charging plan information, and outputs the predetermined information according to a result of the determination.
   6. An electric vehicle management apparatus including:
a charging plan acquisition unit that acquires charging plan information indicating a charging timing of an electric vehicle incorporated with a battery;
a charging state acquisition unit that acquires charging state information indicating a charging state of the electric vehicle at predetermined timing; and
an output unit that determines whether a predetermined output is required by using a charging state indicated by the charging state information and a charging state at the predetermined timing in the charging plan information, and outputs the predetermined information according to a result of the determination.
   7. The electric vehicle management apparatus according to supplementary note 6, wherein
the charging state includes at least two of a state in which a charging connector is unconnected, a state in which a charging connector is connected, a state in which charging is being performed, and a state in which charging is completed.
   8. The electric vehicle management apparatus according to supplementary note 6 or 7, wherein
the output unit outputs a table indicating a state of the electric vehicle,
one item included in the table is the charging state,
the predetermined information is a display mode in the charging state, and,
when a difference between a charging state indicated by the charging state information, and a charging state at the predetermined timing in the charging plan information does not satisfy a criterion, the output unit makes the display mode different with respect to a case where the difference satisfies a criterion.
   9. The electric vehicle management apparatus according to supplementary note 8, wherein
the electric vehicle is plural, and
the table indicates a state of each of a plurality of electric vehicles.
   10. The electric vehicle management apparatus according to any one of supplementary notes 1 to 9, wherein
the output unit outputs information serving as an output target to a terminal of a driver of the electric vehicle serving as the information target, or a terminal of a maintenance worker of the electric vehicle.
   11. The electric vehicle management apparatus according to any one of supplementary notes 1 to 10, further including
a parameter acquisition unit that acquires SOH of the electric vehicle, wherein
the output unit further outputs the SOH.
   12. The electric vehicle management apparatus according to supplementary note 11, wherein
the output unit outputs information indicating the electric vehicle in which a deterioration state of the SOH satisfies a criterion.
   13. The electric vehicle management apparatus according to supplementary note 12, wherein
a deterioration state of the SOH includes a lowering amount of the SOH during a unit period.
   14. An electric vehicle management method including,
by a computer:
   acquiring vehicle identification information of at least one electric vehicle incorporated with a battery, and charging plan information indicating a charging schedule period of the electric vehicle associated with the vehicle identification information, in association with each other;
   acquiring the vehicle identification information of a target vehicle being the electric vehicle for which operation timing is determined, and the operation timing, in association with each other; and
   outputting first vehicle information indicating the target vehicle, when the charging plan information of the target vehicle is absent, or when it is indicated that charging is not completed before the operation timing in the charging plan information.
      15. The electric vehicle management method according to supplementary note 14, wherein
the electric vehicle is plural,
the electric vehicle management method further including,
by the computer,
   outputting second vehicle information indicating the electric vehicle in which the charging schedule period is set.
      16. The electric vehicle management method according to supplementary note 15, further including,
by the computer
   causing to display or print the first vehicle information and the second vehicle information in a different mode from each other.
      17. The electric vehicle management method according to supplementary note 16, further including,
by the computer,
   outputting a table indicating a state of each of the plurality of electric vehicles, wherein,
in the table, the first vehicle information and the second vehicle information are indicated in a same row or a same column.
   18. The electric vehicle management method according to any one of supplementary notes 14 to 17, further including,
by the computer:
   acquiring charging state information indicating a charging state of the electric vehicle at predetermined timing; and
   determining whether a predetermined output is required by using a charging state indicated by the charging state information and a charging state at the predetermined timing in the charging plan information, and outputting the predetermined information according to a result of the determination.
      19. An electric vehicle management method including,
by a computer:
   acquiring charging plan information indicating a charging timing of an electric vehicle incorporated with a battery;
   acquiring charging state information indicating a charging state of the electric vehicle at predetermined timing; and
   determining whether a predetermined output is required by using a charging state indicated by the charging state information and a charging state at the predetermined timing in the charging plan information, and outputting the predetermined information according to a result of the determination.
      20. The electric vehicle management method according to supplementary note 19, wherein
the charging state includes at least two of a state in which a charging connector is unconnected, a state in which a charging connector is connected, a state in which charging is being performed, and a state in which charging is completed.
   21. The electric vehicle management method according to supplementary note 19 or 20, further including,
by the computer,
   outputting a table indicating a state of the electric vehicle, wherein one item included in the table is the charging state,
the predetermined information is a display mode in the charging state,
the electric vehicle management method further including,
by the computer,
   when a difference between a charging state indicated by the charging state information, and a charging state at the predetermined timing in the charging plan information does not satisfy a criterion, making the display mode different with respect to a case where the difference satisfies a criterion.
      22. The electric vehicle management method according to supplementary note 21, wherein
the electric vehicle is plural, and
the table indicates a state of each of a plurality of electric vehicles.
   23. The electric vehicle management method according to any one of supplementary notes 14 to 22, further including,
by the computer,
   outputting information serving as an output target to a terminal of a driver of the electric vehicle serving as the information target, or a terminal of a maintenance worker of the electric vehicle.
      24. The electric vehicle management method according to any one of supplementary notes 14 to 23, further including,
by the computer,
   acquiring SOH of the electric vehicle, and further outputting the SOH.
      25. The electric vehicle management method according to supplementary note 24, further including,
by the computer,
   outputting information indicating the electric vehicle in which a deterioration state of the SOH satisfies a criterion.
      26. The electric vehicle management method according to supplementary note 25, wherein
a deterioration state of the SOH includes a lowering amount of the SOH during a unit period.
   27. A program causing a computer to include:
a charging plan acquiring function of acquiring vehicle identification information of at least one electric vehicle incorporated with a battery, and charging plan information indicating a charging schedule period of the electric vehicle associated with the vehicle identification information, in association with each other;
an operation plan acquiring function of acquiring the vehicle identification information of a target vehicle being the electric vehicle for which operation timing is determined, and the operation timing, in association with each other; and
an output function of outputting first vehicle information indicating the target vehicle, when the charging plan information of the target vehicle is absent, or when it is indicated that charging is not completed before the operation timing in the charging plan information.
   28. The program according to supplementary note 27, wherein
the electric vehicle is plural, and
the output function outputs second vehicle information indicating the electric vehicle in which the charging schedule period is set.
   29. The program according to supplementary note 28, wherein
the output function causes to display or print the first vehicle information and the second vehicle information in a different mode from each other.
   30. The program according to supplementary note 29, wherein
the output function outputs a table indicating a state of each of the plurality of electric vehicles, and,
in the table, the first vehicle information and the second vehicle information are indicated in a same row or a same column.
   31. The program according to any one of supplementary notes 27 to 30, further causing the computer to include
a charging state acquiring function of acquiring charging state information indicating a charging state of the electric vehicle at predetermined timing, wherein
the output function determines whether a predetermined output is required by using a charging state indicated by the charging state information and a charging state at the predetermined timing in the charging plan information, and outputs the predetermined information according to a result of the determination.
   32. A program causing a computer to include:
a charging plan acquiring function of acquiring charging plan information indicating a charging timing of an electric vehicle incorporated with a battery;
a charging state acquiring function of acquiring charging state information indicating a charging state of the electric vehicle at predetermined timing; and
an output function of determining whether a predetermined output is required by using a charging state indicated by the charging state information and a charging state at the predetermined timing in the charging plan information, and outputting the predetermined information according to a result of the determination.
   33. The program according to supplementary note 32, wherein
the charging state includes at least two of a state in which a charging connector is unconnected, a state in which a charging connector is connected, a state in which charging is being performed, and a state in which charging is completed.
   34. The program according to supplementary note 32 or 33, wherein
the output function outputs a table indicating a state of the electric vehicle,
one item included in the table is the charging state,
the predetermined information is a display mode in the charging state, and,
when a difference between a charging state indicated by the charging state information, and a charging state at the predetermined timing in the charging plan information does not satisfy a criterion, the output function makes the display mode different with respect to a case where the difference satisfies a criterion.
   35. The program according to supplementary note 34, wherein
the electric vehicle is plural, and
the table indicates a state of each of a plurality of electric vehicles.
   36. The program according to any one of supplementary notes 27 to 35, wherein
the output function outputs information serving as an output target to a terminal of a driver of the electric vehicle serving as the information target, or a terminal of a maintenance worker of the electric vehicle.
   37. The program according to any one of supplementary notes 27 to 36, further causing the computer to include
a parameter acquiring function of acquiring SOH of the electric vehicle, wherein
the output function further outputs the SOH.
   38. The program according to supplementary note 37, wherein
the output function outputs information indicating the electric vehicle in which a deterioration state of the SOH satisfies a criterion.
   39. The program according to supplementary note 38, wherein
a deterioration state of the SOH includes a lowering amount of the SOH during a unit period.

### REFERENCE SIGNS LIST

10 Electric vehicle management apparatus
20 Driver terminal
30 Maintenance worker terminal
40 Vehicle state storage unit
50 Vehicle state update apparatus
60 Plan storage unit
70 Plan update apparatus
110 Charging plan acquisition unit 110
120 Operation plan acquisition unit
130 Charging state acquisition unit
140 Vehicle data acquisition unit
150 Output unit

What is claimed is:

1. An electric vehicle management apparatus comprising:
at least one memory configured to store instructions; and
at least one processor configured to execute the instructions to:
acquire vehicle identification information of at least one electric vehicle incorporated with a battery, and charging plan information indicating a charging schedule period of the electric vehicle associated with the vehicle identification information, in association with each other;
acquire the vehicle identification information of a target vehicle being the electric vehicle for which operation timing is determined, and the operation timing, in association with each other; and
output first vehicle information indicating the target vehicle, when the charging plan information of the target vehicle is absent, or when it is indicated that charging is not completed before the operation timing in the charging plan information.

2. The electric vehicle management apparatus according to claim 1, wherein
the electric vehicle is plural, and
the at least one processor is further configured to execute the instructions to
output second vehicle information indicating the electric vehicle in which the charging schedule period is set.

3. The electric vehicle management apparatus according to claim 2, wherein
the at least one processor is further configured to execute the instructions to
cause to display or print the first vehicle information and the second vehicle information in a different mode from each other.

4. The electric vehicle management apparatus according to claim 3, wherein
the at least one processor is further configured to execute the instructions to
output a table indicating a state of each of the plurality of electric vehicles, and,
in the table, the first vehicle information and the second vehicle information are indicated in a same row or a same column.

5. The electric vehicle management apparatus according to claim 1, further comprising wherein the at least one processor is further configured to execute the instructions to:
acquire charging state information indicating a charging state of the electric vehicle at predetermined timing; and
determine whether a predetermined output is required by using a charging state indicated by the charging state information and a charging state at the predetermined timing in the charging plan information, and output the predetermined information according to a result of the determination.

6. (canceled)

7. The electric vehicle management apparatus according to claim 5, wherein
the charging state includes at least two of a state in which a charging connector is unconnected, a state in which a charging connector is connected, a state in which charging is being performed, and a state in which charging is completed.

8. The electric vehicle management apparatus according to claim 7, wherein
the at least one processor is further configured to execute the instructions to output a table indicating a state of the electric vehicle,
one item included in the table is the charging state,
the predetermined information is a display mode in the charging state, and,
when a difference between a charging state indicated by the charging state information, and a charging state at the predetermined timing in the charging plan information does not satisfy a criterion,
the at least one processor is further configured to execute the instructions to make the display mode different with respect to a case where the difference satisfies a criterion.

9. The electric vehicle management apparatus according to claim 8, wherein
the electric vehicle is plural, and
the table indicates a state of each of a plurality of electric vehicles.

10. The electric vehicle management apparatus according to claim 1, wherein
the at least one processor is further configured to execute the instructions to output information serving as an output target to a terminal of a driver of the electric vehicle serving as the information target, or a terminal of a maintenance worker of the electric vehicle.

11. The electric vehicle management apparatus according to claim 1, further comprising wherein the at least one processor is further configured to execute the instructions to:
acquire SOH of the electric vehicle; and
further output the SOH.

12. The electric vehicle management apparatus according to claim 11, wherein
the at least one processor is further configured to execute the instructions to output information indicating the electric vehicle in which a deterioration state of the SOH satisfies a criterion.

13. The electric vehicle management apparatus according to claim 12, wherein
a deterioration state of the SOH includes a lowering amount of the SOH during a unit period.

14. An electric vehicle management method comprising,
by a computer:
acquiring vehicle identification information of at least one electric vehicle incorporated with a battery, and charging plan information indicating a charging schedule period of the electric vehicle associated with the vehicle identification information, in association with each other;
acquiring the vehicle identification information of a target vehicle being the electric vehicle for which operation timing is determined, and the operation timing, in association with each other; and
outputting first vehicle information indicating the target vehicle, when the charging plan information of the target vehicle is absent, or when it is indicated that charging is not completed before the operation timing in the charging plan information.

15. The electric vehicle management method according to claim 14,
by the computer:
acquiring charging state information indicating a charging state of the electric vehicle at predetermined timing; and
determining whether a predetermined output is required by using a charging state indicated by the charging state information and a charging state at the predetermined timing in the charging plan information, and outputting the predetermined information according to a result of the determination.

16. A non-transitory computer-readable storage medium storing a program causing a computer to perform:
acquiring vehicle identification information of at least one electric vehicle incorporated with a battery, and charging plan information indicating a charging schedule period of the electric vehicle associated with the vehicle identification information, in association with each other;
acquiring the vehicle identification information of a target vehicle being the electric vehicle for which operation timing is determined, and the operation timing, in association with each other; and
outputting first vehicle information indicating the target vehicle, when the charging plan information of the target vehicle is absent, or when it is indicated that charging is not completed before the operation timing in the charging plan information.

17. The non-transitory computer-readable storage medium according to claim 16, wherein the program causes the computer to further perform:
acquiring charging state information indicating a charging state of the electric vehicle at predetermined timing; and
determining whether a predetermined output is required by using a charging state indicated by the charging state information and a charging state at the predetermined timing in the charging plan information, and outputting the predetermined information according to a result of the determination.
